(19) United States
(12) Patent Application Publication
(10) Pub. No.: US 2026/0220687 A1
(43) Pub. Date: Jul. 30, 2026

(54) SYSTEM AND METHOD FOR PATIENT-PROVIDER SEARCH AND MATCHING TO IMPROVE HEALTHCARE CONNECTIONS

(71) Applicant: Evernorth Strategic Development, Inc., St. Louis, MO (US)

(72) Inventors: Alexandra Krafft, Los Angeles, CA (US); Matthew T. Lawyer, Westlake Village, CA (US); Pranav P. Dhruv, Santa Monica, CA (US); Ching Y. Lau, Arcadia, CA (US)

(21) Appl. No.: 19/571,014

(22) Filed: Mar. 18, 2026

Related U.S. Application Data
(63) Continuation-in-part of application No. 18/387,690, filed on Nov. 7, 2023.
(60) Provisional application No. 63/423,360, filed on Nov. 7, 2022.

(51) Int. Cl. G06Q 30/0601; G06F 40/40; G06Q 30/0282

(52) U.S. Cl. CPC G06Q 30/0631; G06F 40/40; G06Q 30/0282

(57) ABSTRACT

A patient-provider matching system includes one or more processors that transform natural-language queries into structured, machine-readable representations of user intent to improve healthcare connections; generate supplemental questions to refine ambiguous queries and convert responses into structured features for efficient ranking; and apply a predictive model operating on patient data and provider data to generate a ranked list of providers based on selection probabilities and system criteria. The processor(s) reduce computational load by applying constraints, such as geographic location determination using centroid logic, to narrow candidate sets prior to ranking; generate provider review highlights using natural language processing models to enhance user decision-making; and control a graphical user interface to display the ranked list, including provider profiles and map visualizations. As a result, the system enhances retrieval efficiency, reduces network usage, and improves ranking stability to provide personalized healthcare recommendations for physical and mental health needs.

### CROSS-REFERENCE TO RELATED APPLICATIONS

This application is a continuation-in-part of U.S. patent application Ser. No. 18/387,690 (filed 7 Nov. 2023), which claims priority to U.S. Provisional Patent Application No. 63/423,360 (filed 7 Nov. 2022), the entire disclosures of which are incorporated herein by reference.

### TECHNICAL FIELD

Systems and methods herein generally relate to generating optimized search results. More specifically, but not by way of limitations, embodiments herein describe a patient provider matching system.

### BACKGROUND

Many patients rely on family and friends for referrals of medical care providers. Others rely on their insurance provider directory or hospital websites.

In computerized provider-search systems, the underlying datasets can include heterogeneous and high-cardinality records, including provider directories, patient reviews, and claims and utilization records. Conventional keyword matching and static filtering techniques often require repeated user-driven refinement (e.g., repeated manual filtering, repeated navigation of multiple user interface screens, and repeated query re-entry) to obtain a sufficiently relevant result set. Such approaches can increase server load and network traffic due to repeated search requests, can increase latency due to repeated full-scan or wide candidate-set processing, and can yield unstable or low-quality results when the user query is ambiguous, incomplete, or expressed in natural language.

Additionally, conventional systems typically treat query refinement as a user experience problem rather than a computational problem, resulting in inefficient use of computing resources. For example, repeated retrieval and ranking of large candidate sets can consume processor cycles and memory bandwidth, while also increasing response times experienced by client devices. As a result, computerized provider-search systems can exhibit poor scalability and degraded performance as data volume and query diversity increase.

### BRIEF SUMMARY

Examples described herein address the foregoing technical limitations of computerized provider-search systems by implementing a machine-implemented provider search and matching architecture that programmatically transforms an initial natural-language query into (i) a constrained, machine-readable representation of user intent and (ii) a reduced set of candidate providers suitable for efficient ranking. The system can generate and cause presentation of a set of supplemental questions selected based on an analysis of the initial query and, in some examples, based on ambiguity detected in the query representation. Responses to the supplemental questions are converted into structured features and are used to reduce a search space of candidate providers and to generate a ranked list using a predictive model operating on defined patient and provider feature sets.

The system can improve computer performance of provider-search operations by reducing redundant retrieval operations and reducing a size of candidate sets subjected to computationally expensive scoring and re-ranking. For example, by generating supplemental questions that disambiguate the query prior to ranking, the system decreases repeated query submissions and reduces server-side computations that would otherwise be performed across large numbers of providers. The system can improve response latency by applying location determination logic (including centroid-based location derivation) to constrain candidate retrieval to a defined geographic region prior to model-based ranking, which can reduce the number of records loaded into memory and evaluated during scoring.

Accordingly, examples of the systems and methods described herein improve the functioning of the computerized provider-search system itself, including improved retrieval efficiency, reduced computational load, reduced network usage, and improved ranking stability for ambiguous or underspecified queries, while producing a ranked list of provider results for display on a client device.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an example implementation of a healthcare system including a patient provider matching system, according to example embodiments.

FIG. 2 illustrates a database associated with the patient provider matching system, according to example embodiments.

FIG. 3 is a block diagram of a patient provider matching system, according to example embodiments.

FIG. 4 is an illustration of a patient provider matching system, according to example embodiments.

FIG. 5 is an illustration of the natural language processing model, according to example embodiments.

FIG. 6 is an illustration of the patient provider matching system, according to example embodiments.

FIG. 7 illustrates an example physical health query type guided user experience flow.

FIG. 8 illustrates example physical health provider profiles.

FIG. 9 illustrates an example mental health query type guided user experience flow.

FIG. 10 illustrates an example mental health provider profile.

FIG. 11 is a flowchart of an example method for generating a ranked list of search results using a patient provider matching system, according to example embodiments.

FIG. 12 is a block diagram illustrating a software architecture, which can be installed on any one or more of the devices described herein.

FIG. 13 is a diagrammatic representation of the machine within which instructions (e.g., software, a program, an application, an applet, an app, or other executable code) for causing the machine to perform any one or more of the methodologies discussed herein may be executed.

FIG. 14 is a diagrammatic representation of the neural network according to example embodiments.

### DETAILED DESCRIPTION

Finding a medical care provider that serves a patient's unique needs is a highly personalized process. Embodiments described herein provide a patient provider matching system and method for providing a personalized search experience that highlights factors that are most or more important for patients in choosing their medical care provider. A medical care provider can treat any combination of a patient's physical health, mental health and emotional health.

Examples described herein address the foregoing technical limitations of computerized provider-search systems by implementing a machine-implemented provider search and matching architecture that programmatically transforms an initial natural-language query into a constrained, machine-readable representation of user intent and a reduced set of candidate providers suitable for efficient ranking. In examples, the system and method generate and cause presentation of a set of supplemental questions selected based on an analysis of the initial query and, in some implementations, based on ambiguity detected in the query representation. Responses to the supplemental questions are converted into structured features and are used to reduce a search space of candidate providers and to generate a ranked list using a predictive model operating on defined patient and provider feature sets.

In some examples, the system and method improve computer performance of provider-search operations by reducing redundant retrieval operations and reducing a size of candidate sets subjected to computationally expensive scoring and re-ranking. For example, by generating supplemental questions that disambiguate the query prior to ranking, the system and method decrease repeated query submissions and reduce server-side computations that would otherwise be performed across large numbers of providers. The system and method can improve response latency by applying location determination logic (including centroid-based location derivation) to constrain candidate retrieval to a defined geographic region prior to model-based ranking. This can reduce the number of records loaded into memory and evaluated during scoring.

Accordingly, examples of the systems and methods described herein provide an improvement in the functioning of the computerized provider-search system itself, including improved retrieval efficiency, reduced computational load, reduced network usage, and improved ranking stability for ambiguous or underspecified queries, while producing a ranked list of provider results for display on a client device.

The patient provider matching system receives a query by a patient user device and identifies a list of medical providers that match the query based on provider qualifications and medical claims data. The patient provider matching system ranks the identified list of medical providers based on patient data and provider data. The patient provider matching system displays the ranked list of medical providers on a graphical user interface for the patient user. The ranked list of medical providers may be generated by applying one or more predictive models to the database and inputs from the patient user device. Further details of the patient provider matching system are provided below. These operations can occur within a dedicated computing machine executing instructions.

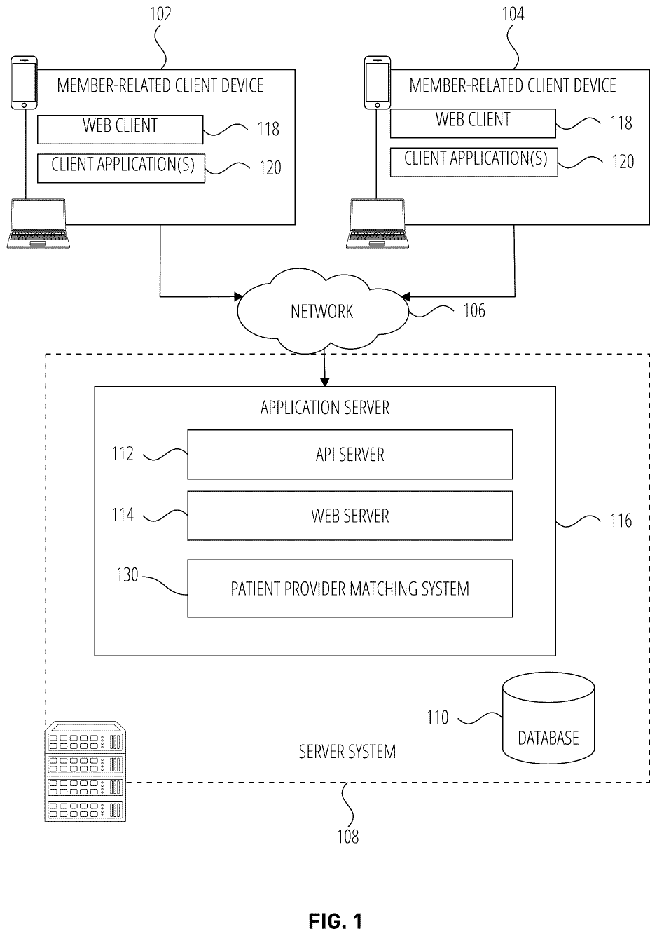

FIG. 1 is a block diagram showing an example healthcare system according to various exemplary embodiments, configured to match patients with providers according to a set of patient preferences. The healthcare system may further be used to check the status of member healthcare claim data, check member healthcare coverage benefits, etc. The healthcare system includes one or more client devices such as member-related client device 102 and member-related client device 104. A client device may be, but is not limited to, a mobile phone, desktop computer, laptop, portable digital assistants (PDAs), smart phones, a wearable device (e.g., a smart watch), tablets, ultrabooks, netbooks, laptops, multi-processor systems, microprocessor-based or programmable consumer electronics, game consoles, set-top boxes, or any other communication device that a user may use to access a network (e.g., dedicated electronic computing devices that execute instructions to perform process steps as described herein). The member-related client device 102 and member-related client device 104 can include a microphone and speaker on a mobile electronic device, a telephone, or a self-service kiosk, e.g., at a pharmacy, a clinic, a doctor's office, a mobile relief center, and the like.

The member-related client device 102 and member-related client device 104 may be devices of users that are used to access and utilize an online healthcare platform. For example, each of the member-related client device 102 and member-related client device 104 may be used to input information to create an account, access a member profile, view patient providers, and so forth.

For example, member-related client device 102 is a device(s) of a given user who would like to search for a provider for a specific healthcare need. Member-related client device 102 accesses a website of a healthcare platform (e.g., hosted by server system 108). The user inputs, into a client device, login credentials associated with the user. Server system 108 receives the request and provides access to the online healthcare platform.

One or more users may be a person, a machine, or other means of interacting with the member-related client device 102 or member-related client device 104. In example embodiments, the user may not be part of the system but may interact with the system via the member-related client device 102 or member-related client device 104 or other means. For example, a user may provide input to the member-related client device 102 and the input may be communicated to the server system 108 via the network 106.

The healthcare system can further include and/or be connected with a network 106. The network 106 may include, or operate in conjunction with, an ad hoc network, an intranet, an extranet, a virtual private network (VPN), a local area network (LAN), a wireless network, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The member-related client device 102 and member-related client device 104 may access the various data and applications provided by other entities via the web client 118 (e.g., a browser) or one or more client application(s) 120. The member-related client device 102 and member-related client device 104 may include one or more client application(s) 120 such as, but not limited to, a web browser, a healthcare application, electronic mail (email) application, an e-commerce site application, a mapping or location application, and the like.

In some embodiments, one or more client application(s) 120 are included in a given member-related client device 102 and member-related client device 104, and configured to locally provide the user interface at least some of the functionalities, with the client application(s) 120 configured to communication with the server system 108 on an as-needed bases, for data processing capabilities not locally available. Conversely, one or more client application(s) 120 may not be included in the member-related client device 102 or member-related client device 104, and the client devices may use its web browser to access the one or more applications hosted on the server system 108.

A server system 108 provides server-side functionality via the network 106 to the member-related client device 102 and member-related client device 104. The server system 108 includes an application program interface (API) server 112, a web server 114 and patient provider matching system 130, that may be communicatively coupled with one or more database(s) 110. The one or more database(s) 110 may be storage devices that store data related to users of the server system 108, applications associated with the server system 108, cloud services, and so forth. In one example, the one or more database(s) 110 may be cloud-based storage.

The server system 108 may be cloud computing environment, according to some example embodiments. The server system 108, and any servers associated with the server system 108 may be associated with a cloud-based application, in one embodiment.

The server system 108 includes a patient provider matching system 130. The patient provider matching system 130 enables a patient user using a patient device (e.g. member-related client device 102 and member-related client device 104) to search for providers that match their preferences. The patient provider matching system 130 generates a list of supplemental questions for the patient user based on the patient user's search query to further refine the search results. Based on the patient users' responses to the list of supplemental questions, the provider matching system 130 generates a ranked list of providers. The ranked list generated by the patient provider matching system 130 further provides additional data about each provider that a patient user may find beneficial when selecting a provider. The responses can be fed into a predictive model to generate the ranked list.

In some examples, the healthcare system includes a customer service client device (not pictured). The customer service client device may be used to establish a communication session (e.g., via a network 106) to one or more of the member-related client device 102 and member-related client device 104. The customer service client device may further be used to access and utilize functionalities of the server system 108.

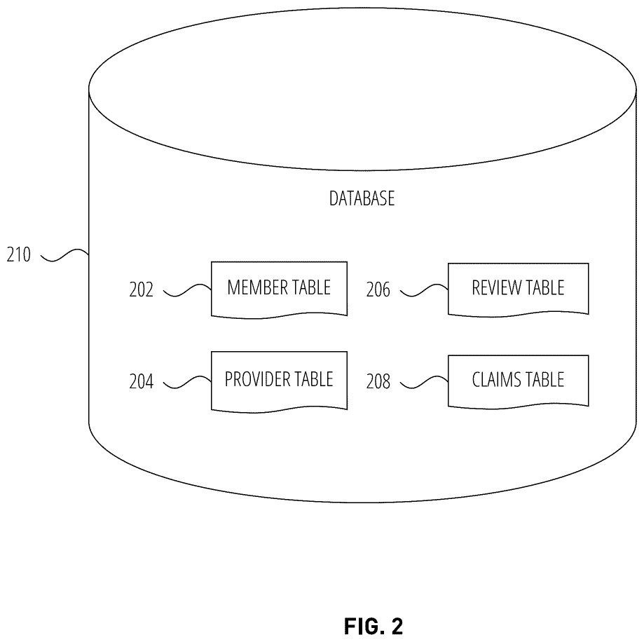

FIG. 2 is a schematic diagram illustrating data that is stored in the database 110 of the server system 108, according to certain exemplary embodiments. While the content of the database 110 is shown to comprise a number of tables, the data could be stored in other types of data structures (e.g., as an object-oriented database). The database 110 is shown to include a member table 202, a provider table 204, review table 206, and claims table 208.

The member table 202 includes information regarding the members associated with the healthcare system. The information stored as member table 202 may include personal information, personal health information, protected health information, etc. Examples of the member table 202 include name, address, telephone number, e-mail address, prescription drug history, etc. The member table 202 may include a plan sponsor identifier that identifies the plan sponsor associated with the member and/or a member identifier that identifies the member to the plan sponsor. The member table 202 may include a member identifier that identifies the plan sponsor associated with the user and/or a user identifier that identifies the user to the plan sponsor. The member table 202 may also include dispensation preferences such as type of label, type of cap, message preferences, language preferences, etc.

The member table 202 may be accessed by the patient provider matching system 130 for review, verification, or other purposes. In general, the use of the terms “member” and “user” may be used interchangeably.

The provider table 204 includes information regarding the providers associated with the healthcare system. Examples of the provider table 204 include name, address, telephone number, e-mail address, specialty, education background, practice history, etc. The provider table 204 may further include provider ratings, and indicators that represent whether a specific provider is a recommended provider.

The review table 206 includes information regarding member reviews of a given provider. Examples of the review table 206 include phrases, full sentences, partial sentences, or any suitable textual description of a given provider written by a member.

The claims table 208 includes information regarding medical claims. In general, the claims table 208 include information such as diagnoses, treatments, and other patient-provider information.

In some implementations, other types of claims beyond prescription drug claims may be stored in the claims table 208. For example, pharmacy claims, dental claims, wellness claims, or other types of health-care-related claims for members may be stored as a portion of the claims table 208.

In some implementations, the claims table 208 includes claims that identify the members with whom the claims are associated. Additionally, or alternatively, the claims table 208 may include claims that have been de-identified (that is, associated with a unique identifier but not with a particular, identifiable member).

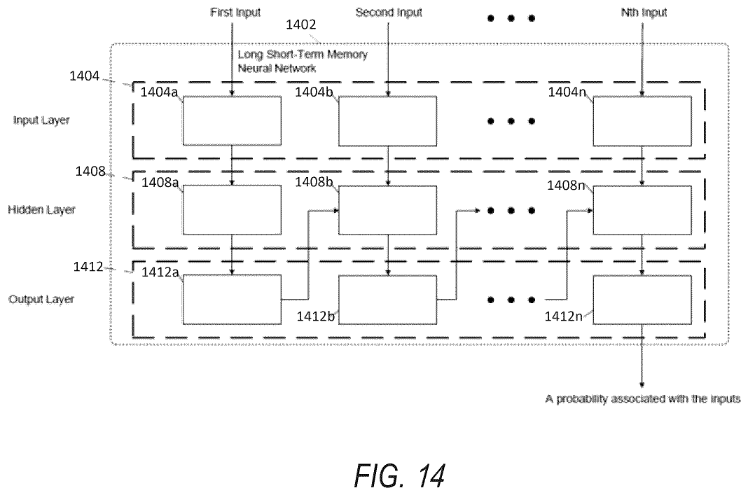

A models sub-database 209 stores models to be used on the data in the database to use data as inputs to assist in generating a provider match. The models may be created with the methodology described with reference to FIG. 14.

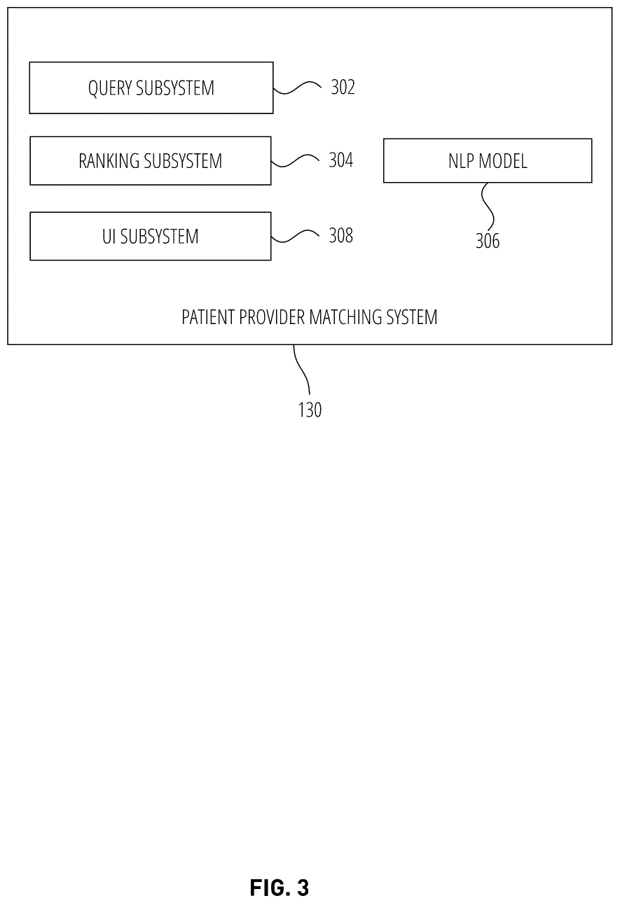

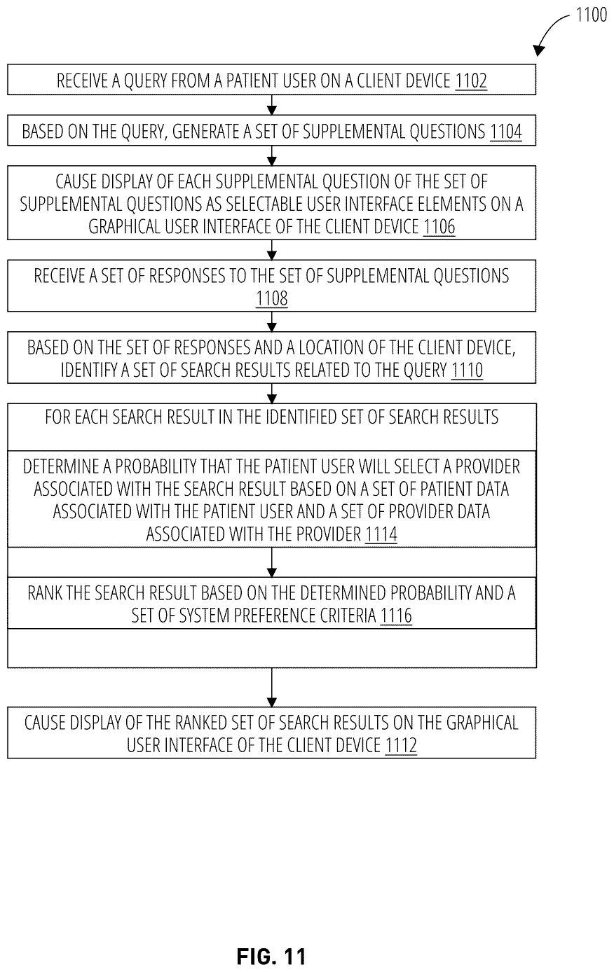

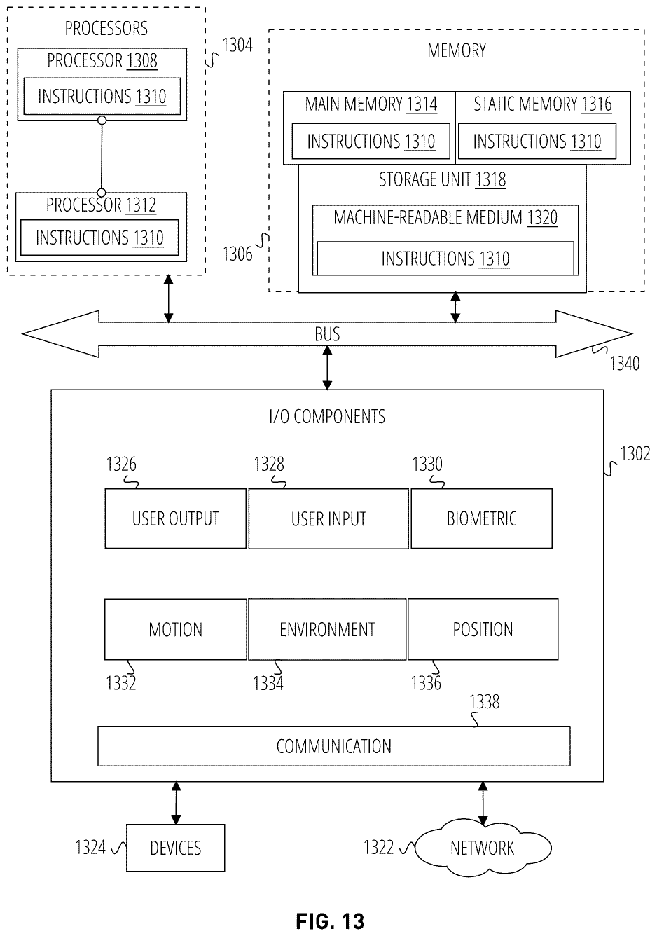

The patient provider matching system 130 in FIG. 3 includes a query subsystem 302, ranking subsystem 304, an NLP Model 306, and a UI Subsystem 308. The patient provider matching system 130 can further include elements described with respect to FIG. 13 and FIG. 11 as a processor and memory, having instructions stored thereon, that when executed by the processor, causes the processor to control the functions of the patient provider matching system 130.

The query subsystem 302 receives a query provided by the patient user. The query includes a set of patient preferences associated with the patient user. The patient user may provide the query as input via a graphical user interface provided by the UI Subsystem 308. For example, the UI Subsystem 308 may display a text field, drop down elements, checkboxes, or any suitable interactive user interface elements for receiving the query. In some examples, the query received by the query subsystem 302 is a search for medical providers for the patient user. The patient preferences include the patient user's requirements for a medical provider that is recommended by the patient provider matching system 130. For example, patient preferences may include a practice area of the provider, age or gender of the provider, age or gender of the patient, location of the patient and/or provider, and the like (which are stored in data fields within a memory accessible by a processor). After receiving the query, the query subsystem 302 generates a list of supplemental questions associated with the query. The query subsystem 302 causes display of the supplemental questions as interactive user interface elements on the graphical user interface provided by the UI Subsystem 308. In some examples, the supplemental questions are displayed in a pre-determined order. The supplemental questions are used by the query subsystem 302 to further refine the query provided by the patient user.

The ranking subsystem 304 identifies search results (e.g., medical providers) that match the query received by the query subsystem 302 and generates a ranked list of search results. The ranking subsystem 304 uses claims data from the claims table 208 and provider data from the provider table 204 to identify the search results. For example, the ranking subsystem 304 uses data relating to the providers (e.g., the provider's specialty, sub-specialties, procedure history, scheduling availability, and the like).

To identify search results that match the query, the ranking subsystem 304 may further access the location of the patient user's device (e.g., member-related client device 102, member-related client device 104), data from the database 110, for example. In some examples, the ranking subsystem 304 uses a geographical location that is input by the patient user on a website or mobile application that includes the patient provider matching system 130.

The location associated with a patient user can be represented as a polygon corresponding to a patient-associated area, and ranking subsystem 304 can calculate a centroid as a geometric centroid of the polygon. The centroid can be used to define a device-associated location constraint for candidate retrieval, such that candidate providers are retrieved and filtered based at least in part on a distance measure computed relative to the centroid.

For example, the ranking subsystem 304 can use the centroid of the geographic location of the patient user (or patient user's device) to identify search results that match the query. Based on the centroid of the location of the patient user, the ranking subsystem 304 identifies search results that fall within a predefined radius of the centroid (e.g., 2 miles, 5 miles, 50 miles, etc.). The centroid can be the center of a regular polygon, an irregular polygon, include one or more irregular polygons, and/or include curved shapes to form the location of the patient user. The centroid can be determined by minimizing the sum of squared Euclidean distances between itself and each point in the geometric object, by integration, intersection of medians, or geometric decomposition, for example.

In some examples, the ranking subsystem 304 uses the centroid of the closest city associated with the patient user (or patient user's device) to identify search results that match the query. Based on the centroid of the closest city, the ranking subsystem 304 identifies search results that fall within a predefined radius (or other dimensions) of the centroid. If the ranking subsystem 304 identifies that the number of search results (e.g., a size of the set of search results) does not exceed a minimum threshold amount, the ranking subsystem 304 may extend the radius of the centroid until the ranking subsystem 304 identifies a number of search results that meets or exceeds the minimum threshold amount.

In some examples, the ranking subsystem 304 uses both the centroid of the geographic location of the patient user (or patient user's device) and the centroid of the closest city associated with the patient user (or patient user's device) to identify search results that match the query. If the ranking subsystem 304 determines that the centroid of the geographic location exceeds a threshold distance from the centroid of the closest city, the ranking subsystem 304 may generate a notification or trigger an alert to a member-related client device 102 or member-related client device 104.

In some examples, the ranking subsystem 304 analyzes claims data from the claims table 208 to determine which medical providers that patient users in a given region seek care from. In another example, based on the geographic location of the patient user (or patient user's device), the ranking subsystem 304 may use the claims data to identify neighboring regions that patient users seek medical care from medical providers. The ranking subsystem 304 may require that the neighboring regions be within a predefined distance from the primary given region that represents the patient's location. For example, if the patient user lives in a city, the ranking subsystem 304 may use the claims data to determine which medical providers other patient users in the city seek medical care from. However, if the patient user lives in a rural area, the ranking subsystem 304 may need to identify neighboring regions in order to provide the patient user with a more exhaustive list of options of medical providers. The ranking subsystem 304 may require that the identified neighboring regions be within a reasonable distance (e.g., within a 30 minute drive) from the patient's location. The ranking subsystem 304 may further require that a specific percentage of residents from the patient's primary location travel to the identified neighboring regions to seek medical care.

In some examples, the ranking subsystem 304 may identify multiple locations for a single provider. In that instance, the ranking subsystem 304 only retains the location closest to the patient and does not include other locations of the provider in the final ranked list.

The ranking subsystem 304 further includes a predictive model that generates a probability that the patient user will select a given identified provider. The predictive model receives the identified list of providers, patient information and provider information as input and generates an output that represents the probability that the patient user will select the given identified provider. The patient information may include the age and gender of the patient. The provider information may include the gender of the provider, the number of years of experience the provider has in his or her field, the provider's specialties and areas of focus, and the distance of the provider from the patient's location. In some examples the predictive model is a logistics regression model. It is to be understood that the predictive model may be any suitable machine learning model or statistical model.

Based on the probability generated by the predictive model discussed above, the ranking subsystem 304 generates a ranked list of search results. The UI Subsystem 308 causes display of the ranked list of search results on a graphical user interface. Each search result may be displayed as a selectable user interface element (e.g., a button, drop down menu, etc.) that includes the given provider's image, name, professional background, practice area, patient rating, patient review highlights, and further information. For example, the search result may include the provider's specialty, area(s) of focus, relevant procedures, clinical outcomes and quality (e.g., success rate of a given procedure), and the like. A patient user may interact with the ranked list of search results via the UI Subsystem 308 by clicking, tapping, or otherwise selecting a search result and learning more information about the recommended medical providers.

In some examples, the UI subsystem 308 can generate a presentation payload for the ranked list of search results 412 by encoding, into a machine-readable message for transmission over network 106, an ordered set of provider identifiers and associated attributes for rendering on client device 102, 104. The encoded presentation payload can comprise a serialized data structure including the ranked provider entries, geographic coordinates for map visualization, and selectable user interface element descriptors. This can allow for rendering of the ranked list and associated interface elements at client devices 102, 104.

The patient review highlights discussed above may be generated by the Natural Language Processing (NLP) Model 306. For example, the NLP Model 306 may analyze verified patient reviews for a given provider and generate review highlights that a new patient user may find helpful when deciding which provider to select. For example, the NLP Model 306 extracts aspects and sentiments from verified patient reviews. The review highlights may highlight various aspects of the provider including but not limited to aspects of the provider such as whether the provider follows up, has good bedside manner, is knowledgeable, attentive, thorough and professional. The review highlights may also highlight aspects of the staff such as whether the staff is friendly and professional. The review highlights may also highlight aspects of the office, such as whether the office is an efficient office, the patient had a pleasant experience, the office is kid friendly, it is easy to make an appointment, and the wait time is short.

In some examples, the NLP Model 306 uses two sub-models. The first sub-model classifies review segments to positive or non-positive sentiments, and the second sub-model classifies review segments to negative or non-negative sentiments.

In some examples, the UI Subsystem 308 further includes a visualization of a map indicating the locations of each of the providers provided by the ranking subsystem 304. The UI Subsystem 308 may provide functionality for a patient user to interact with the map.

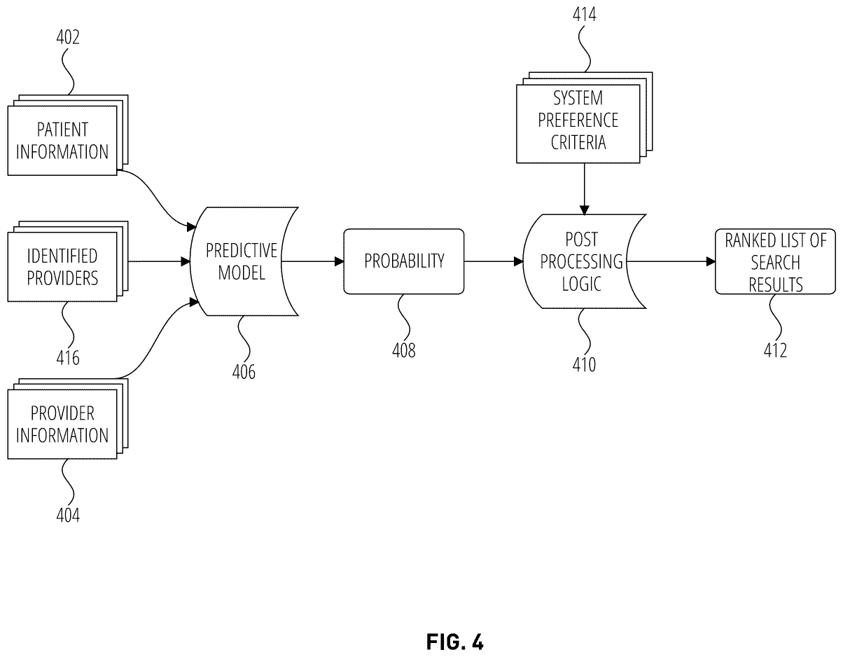

FIG. 4 is an illustration of a patient provider matching system 130, according to example embodiments. The predictive model 406 receives patient information 402, identified providers 416, and provider information 404 as input. The predictive model 406 can be a logistic regression model that is trained on historical provider-selection outcomes. This training can include generating labeled training examples from prior user interactions associated with client devices 102, 104 and constructing patient feature vectors and provider feature vectors derived from one or more of member table 202, provider table 204, review table 206, and claims table 208. The logistic regression model can be trained to output selection-likelihood values representing, for a given query and corresponding structured features derived from supplemental question responses, a probability that a patient user will select a corresponding provider entry.

As discussed above in connection with FIG. 3, the ranking subsystem 304 first identifies a list of providers that matches the query received by the query subsystem 302. The patient information 402 includes but is not limited to the patient's age and patient's gender. The patient information 402 may further include other aspects of the member data from the member table 202. The provider information 404 includes but is not limited to the provider's gender, specialty practice areas, distance from the patient, years of experience, area(s) of focus, patient insights, and review highlights. The provider information 404 may be retrieved from the provider table 204, third party medical claims data, or any combination thereof. The third-party medical claims data may include further information about the provider such as whether they offer virtual or in-person services, couples, individual, group and/or family therapy, and the like. As discussed above, the review highlights are generated by the NLP Model 306.

The predictive model 406 generates a probability 408 for each provider that the patient user will select the given provider. The patient provider matching system 130 performs post processing logic 410 before providing the final ranked list of search results 412 by analyzing the probability 408 and a set system preference criteria 414. The system preference criteria 414 may include the number of patient reviews for the provider, the overall rating of the provider, cost efficiency of the provider's practice, whether the provider is accepting new patients, and the like. The system preference criteria 414 may be related to preferences set by the healthcare system. Further details of the healthcare system may be found in connection with FIG. 1.

After the post processing logic 410, the patient provider matching system 130 generates a ranked list of search results 412. The ranked list of search results 412 is displayed on a graphical user interface and presented to the patient user who submitted the initial query.

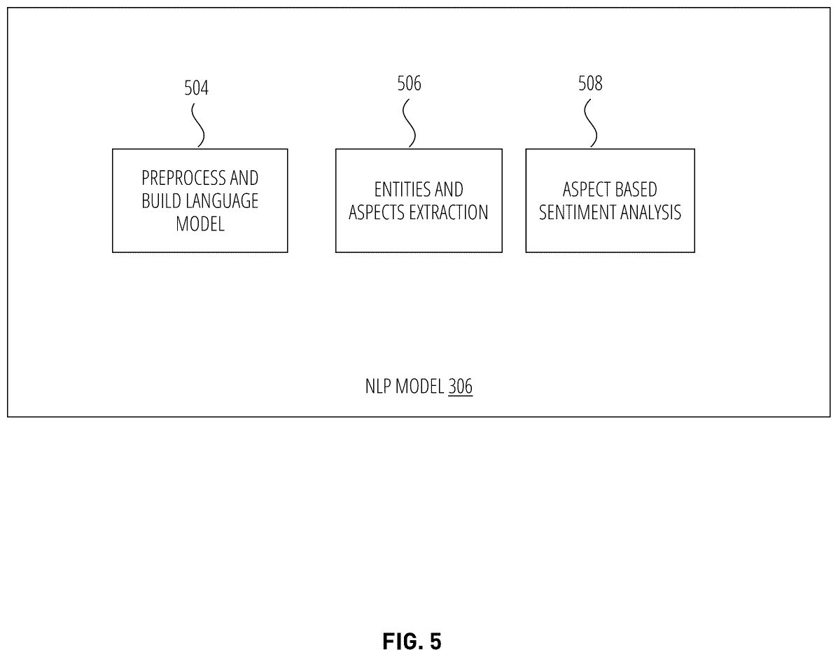

FIG. 5 is an illustration of the NLP Model 306. The NLP Model 306 is shown to include a preprocess and build language model 504, an entities and aspects extraction module 506 and an aspect-based sentiment analysis module 508. The NLP Model 306 is used to extract data from patient reviews. The patient reviews are broken up into segments, and each segment is analyzed using various modules. The entities and aspects extraction module 506 extracts noun phrases and keywords from the patient reviews. The extracted terms are matched with an expanded list of a seed list that is created for each supported entity and aspect. If there are matched terms, the matched entity or aspects will become candidates for segment entity and aspects. The aspect based-sentiment analysis module 508 predicts whether a segment is positive or non-positive as well as negative or non-negative. Segment sentiment is positive if the segment is predicted as both positive and non-negative. Segment sentiment is negative if the segment is predicted as both negative and non-positive. The segment sentiment is neutral otherwise. At a review level, the patient provider matching system 130 counts the number of positive, negative, and neutral segments for each unique provider tag that the review has. If there is at least one negative segment, the review sentiment for that provider tag is negative. If there is no negative segment and there is at least one positive segment, the review sentiment for the provider tag is positive. Otherwise, the review sentiment is neutral. At a provider level, the patient provider matching system 130, counts the number of positive negative, and neutral reviews for each unique provider tag that the provider has. If there is at least one negative review, the provider sentiment for that provider tag is negative. If there are no negative reviews and there is at least one positive review, the provider sentiment for that provider tag is positive. Otherwise, the provider sentiment is neutral.

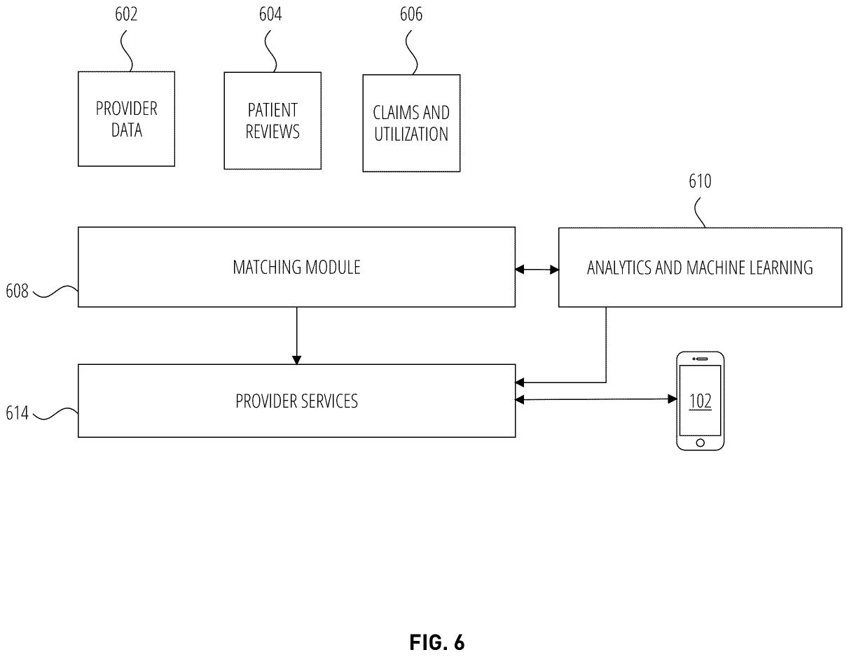

FIG. 6 is an illustration of the patient provider matching system 130. The patient provider matching system 130 uses data from various data sources including provider data 602 (e.g., from the provider table 204), patient reviews 604 (e.g., from the review table 206), claims and utilization data 606 from the claims table 208 and other data such as patient data (e.g., from the member table 202). The patient provider matching system 130 includes a matching module 608 that comprises data (e.g., foundational provider data, experience and personalization enhancements, network and contracting data and cost, clinical outcomes and quality data) that are used to generate a ranked list of search results of providers corresponding to a patient user's query. The matching module 608 undergoes various analytics and data processing using systems in the analytics and machine learning module 610. The systems in the analytics and machine learning module 610 include NLP models (e.g., NLP Model 306) and logistic regression models (e.g., predictive model 406). At the service layer 614, the patient provider matching system 130 includes searchable documents and indexes and application programming interfaces (APIs) that are used to provide the generated ranked list of providers to a patient user (user of a member-related client device 102).

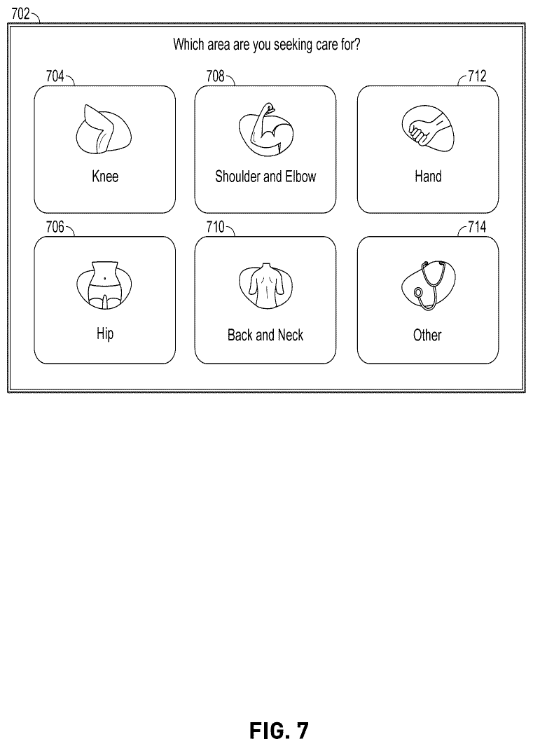

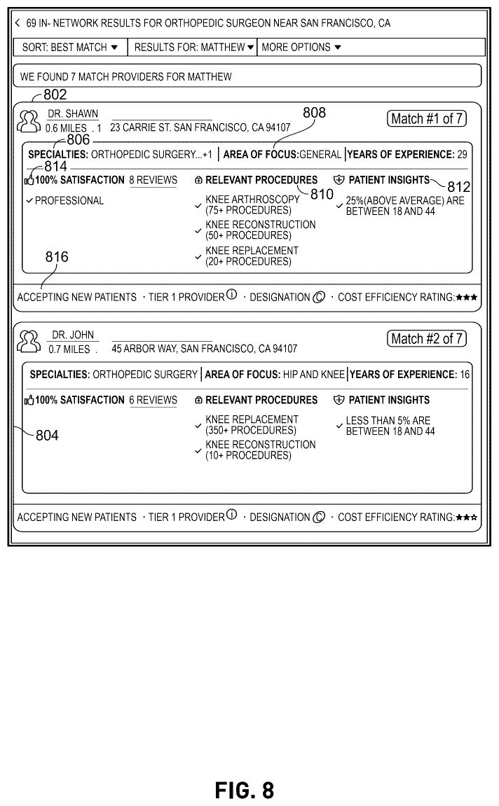

In some examples, the patient provider matching system 130 may provide a different user experience flow based on the type of query provided by the patient user. A determination of the type of query may be made based on the patient's search terms and search categories. For example, a patient user may submit a physical health query type or a mental health query type. A physical health query type may include a different user experience flow than a mental health query type. An example physical health query type flow is illustrated in FIG. 7. After the patient user provides a query, the query subsystem 302 generates a set of supplemental questions. The set of supplemental questions may be displayed using a pop-window or image overlay 702 and includes selectable user interface elements 704, 706, 708, 710, 712, and 714. The patient user may select one or more of the selectable user interface elements. In response to the selection of the one or more selectable user interface elements, the query subsystem 302 may generate further supplemental questions. In some examples, after receiving the selection of the one or more selectable user interface elements, the patient provider matching system 130 generates a ranked list of search results 412. The ranked list of search results 412 may include provider profiles 802 and 804 as shown in FIG. 8. The provider profile 802 is shown to include a specialty 806. The patient provider matching system 130 may retrieve the specialty 806 from a website or third-party data source associated with the provider. The specialty 806 may alternatively be provided by the provider to the patient provider matching system 130 and stored in one or more databases (e.g., provider table 204). The area of focus 808 is inferred based on medical claims analytic insights. In some examples, the area of focus 808 is inferred based on an analysis of third-party medical claims, medical claims data stored in the claims table 208, or a combination thereof.

The relevant procedures 810 include a list of top procedures performed on the body part the patient user needs treated by the specific provider. The relevant procedures 810 may be retrieved from a medical claims database (claims table 208) and a provider database (provider table 204). In some examples the relevant procedures 810 may be retrieved based on medical claims analysis of medical claims received from third-party data sources. The patient insights 812 includes information about a provider's patient panel that is unique to the searching patient user. The verified patient reviews 814 are generated from the NLP Model 306. Quality and affordability information is displayed in a panel 816, that provides the patient user information on how a provider compares to others based on established measures for affordability and quality.

In one example, when the physical health query type includes a search term with an unambiguous specialty, the user experience flow will focus on the care needs and ask for a specific body part the patient user is seeking care for. The user experience flow includes the list of supplemental questions generated by the query subsystem 302. A list of example search terms, and the subsequent guided user experience flow is provided below:

| Search Term | Guided Flow: Body Part Selection |
|---|---|
| Orthopedics Surgeon | Which one area are you seeking care for? |
| Orthopedic Trauma | Spine |
| Sports Medicine | Hand |
| Orthopedics Sports Medicine | Foot and Ankle |
| Pediatric Sports Medicine | Hip |
| | Knee |
| | Shoulder and Elbow |
| | Other |

In another example, when the search term includes an ambiguous specialty without an indication of a specific body part, the guided user experience flow will focus on the care needs and ask for the specific body part the patient user is seeking care for. An example search term and guided user experience flow is provided below:

| Search Term | Guided Flow: Body | |
|---|---|---|
| Example | Part Selection | Guided Flow: Care Selection |
| Bone doctor | Which area are you | Customers also search these |
| | experiencing problems? | specialties for spine related problem |
| | Spine | Chiropractor |
| | Hand | Physical Therapist |
| | Foot and Ankle | Primary Care |
| | Hip and Knee | Sports Medicine |
| | Shoulder and Elbow | Orthopedics |
| | Other | Neurosurgeon |

In another example, when the search term includes an ambiguous specialty with an indication of a specific body part, the guided user experience flow will focus on the care needs. An example search term and corresponding guided user experience flow is provided below:

| Search Term Example | Guided Flow: Care Selection |
|---|---|
| Back doctor/Neck doctor | What type of care are you looking for? |
| | Chiropractor |
| | Physical Therapist |
| | Primary Care |
| | Sports Medicine |
| | Orthopedics |
| | Neurosurgeon |
| Foot doctor | Primary Care |
| | Sports Medicine |
| | Podiatrist |
| | Orthopedic Surgeon |
| Hand doctor | Primary Care |
| | Sports Medicine |
| | Orthopedic Surgeon |

In another example, when the search term includes an ambiguous symptom or condition with an indication of a specific body part, the guided user experience flow will focus on the care needs. An example search term and corresponding guided user experience flow is provided below:

| Search Term Example | Guided Flow |
|---|---|
| Back pain/Neck pain | What type of care are you looking for? |
| | Primary Care |
| | Chiropractor |
| | Physical Therapist |
| | Pain Management |
| | Orthopedic Spine Surgeon |
| | Neurosurgeon |
| Foot pain | Primary Care |
| | Sports Medicine |
| | Podiatrist |
| | Orthopedic Surgeon |
| Hand pain | Primary Care |
| | Sports Medicine |
| | Orthopedic Surgeon |
| Swollen Knee | Primary Care |
| | Sports Medicine |
| | Orthopedic Surgeon |

In another example, when the search term includes an ambiguous symptom or condition without an indication of a specific body part, the guided user experience flow will focus on the body part that the patient user wants to focus their care on. An example search term and corresponding guided user experience flow is provided below:

| Search Term | | Guided Flow 2 (if customer |
|---|---|---|
| Example | Guided Flow | selects Orthopedic Surgeon) |
| Bone pain, | What type of care are | Which area are you experiencing |
| Broken Bone | you looking for? | problems? |
| | Primary Care | Spine |
| | Orthopedic Surgeon | Hand |
| | | Foot and Ankle |
| | | Hip and Knee |
| | | Shoulder and Elbow |
| | | Other |
| Joint Problems | What type of care are | Which area are you experiencing |
| | you looking for? | problems? |
| | Primary Care | Spine |
| | Orthopedic Surgeon | Hand |
| | Rheumatology | Foot and Ankle |
| | | Hip and Knee |
| | | Shoulder and Elbow |
| | | Other |

In some examples, the patient user query may include a search for a specific procedure. For example, if the procedure can only be served by an Orthopedic surgeon, the guided user experience flow will require the patient to input the body part and the procedure name in order to generate the ranked list of search results 412.

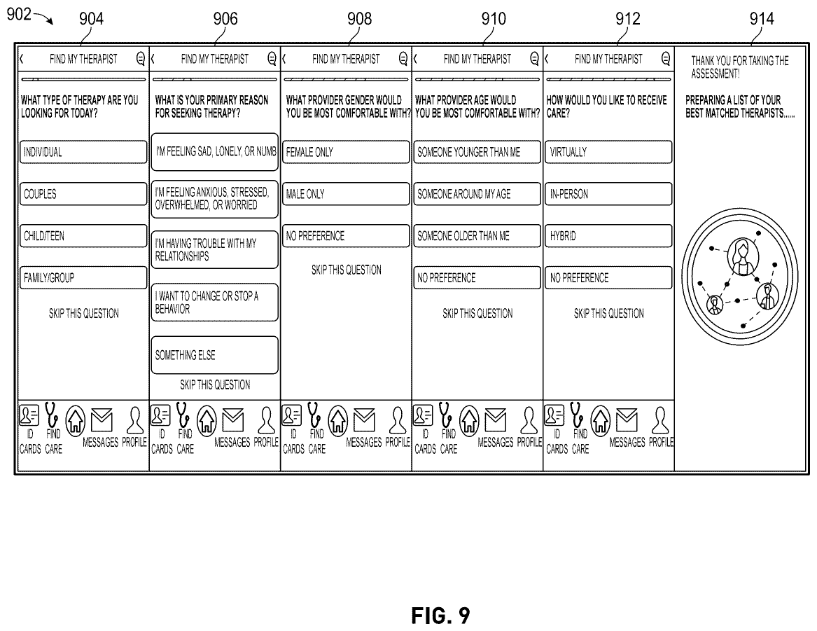

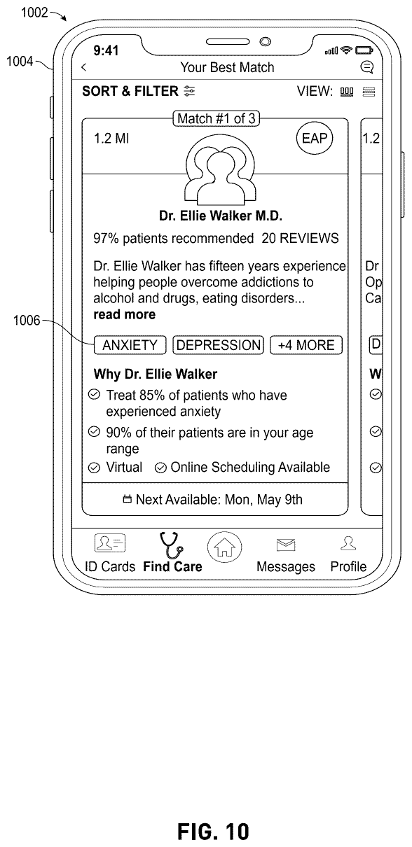

FIG. 9 is an example user experience flow for a mental health type query. FIG. 9 is shown to include user interfaces 904, 906, 908, 910, 912, and 914, which are each displayed to the patient user in a sequential order. After the patient user provides a mental health type query, the query subsystem 302 generates and displays supplemental questions as shown in user interfaces 904-914. The patient user may elect to answer the supplemental question or skip the question entirely. Based on the patient user's responses, the patient provider matching system 130 generates a ranked list of search results 412. An example provider profile 1004 generated by the ranking subsystem 304 is shown in FIG. 10. The provider profile 1004 may differ from the provider profiles 802 and 804. For example, the provider profile 1004 is shown to include multiple areas of focus 1006.

FIG. 11 is a flowchart of an example method 1100 for generating a ranked list of search results using a patient provider matching system 130, according to example embodiments. In one example, the processor in a patient provider matching system 130, the processor in member-related client device 102, member-related client device 104, or any combination thereof can perform the operations in the method 1100.

In operation 1102, the patient provider matching system 130 receives a query from a patient user on a client device. For example, the query may be received by the query subsystem 302.

In operation 1104, based on the query, the patient provider matching system 130 generates a set of supplemental questions. The supplemental questions may be generated by the query subsystem 302.

At operation 1106, the patient provider matching system 130 receives a set of responses to the set of supplemental questions. At operation 1108, based on the set of responses and a location of the client device, the patient provider matching system 130 identifies a set of search results related to the query. For each search result in the identified set of search results, the patient provider matching system 130 determines a probability that the patient user will select a provider associated with the search result based on a set of patient data associated with the patient user and a set of provider data associated with the provider at operation 1110 and ranks the search result based on the determined probability and a set of system preference criteria at operation 1112. For example, the probability is determined using the predictive model 406. The set of patient data may be the patient information 402 and the set of provider data may be the provider information 404. The set of system preference criteria may be the system preference criteria 414. In some examples, operations 1108-1112 may be performed by the ranking subsystem 304. At operation 1114, the patient provider matching system 130 causes display of the ranked set of search results on the graphical user interface of the client device. Operation 1114 may be performed by the UI Subsystem 308.

### Software Architecture

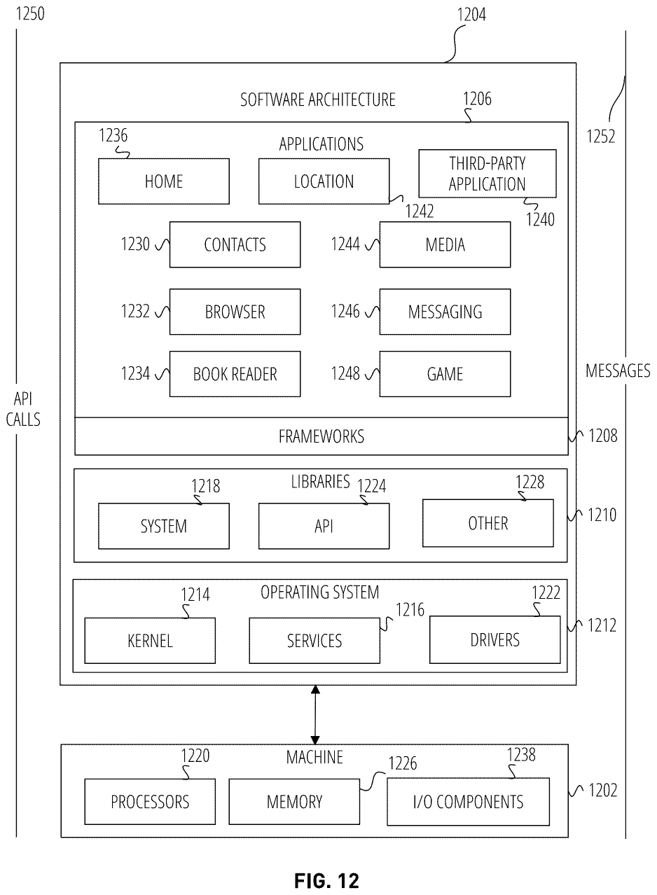

FIG. 12 is a block diagram illustrating a software architecture 1204, which can be installed on any one or more of the devices described herein. The software architecture 1204 is supported by hardware such as a machine 1202 that includes processors 1220, memory 1226, and I/O components 1238. In this example, the software architecture 1204 can be conceptualized as a stack of layers, where each layer provides a particular functionality. The software architecture 1204 includes layers such as an operating system 1212 libraries 1210, frameworks 1208, and applications 1206. Operationally, the applications 1206 invoke API calls 1250 through the software stack and receive messages 1252 in response to the API calls 1250.

The operating system 1212 manages hardware resources and provides common services. The operating system 1212 includes, for example, a kernel 1214, services 1216, and drivers 1222. The kernel 1214 acts as an abstraction layer between the hardware and the other software layers. For example, the kernel 1214 provides memory management, processor management (e.g., scheduling), component management, networking, and security settings, among other functionalities. The services 1216 can provide other common services for the other software layers. The drivers 1222 are responsible for controlling or interfacing with the underlying hardware. For instance, the drivers 1222 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1210 provide a common low-level infrastructure used by the applications 1206. The libraries 1210 can include system libraries 1218 (e.g., C standard library) that provide functions such as memory allocation functions, string manipulation functions, mathematic functions, and the like. In addition, the libraries 1210 can include API libraries 1224 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP 3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1210 can also include a wide variety of other libraries 1228 to provide many other APIs to the applications 1206.

The frameworks 1208 provide a common high-level infrastructure that is used by the applications 1206. For example, the frameworks 1208 provide various graphical user interface (GUI) functions, high-level resource management, and high-level location services. The frameworks 1208 can provide a broad spectrum of other APIs that can be used by the applications 1206, some of which may be specific to a particular operating system or platform.

In an example, the applications 1206 may include a home application 1236, a contacts application 1230, a browser application 1232, a book reader application 1234, a location application 1242, a media application 1244, a messaging application 1246, a game application 1248, and a broad assortment of other applications such as a third-party application 1240. The applications 1206 are programs that execute functions defined in the programs. Various programming languages can be employed to create one or more of the applications 1206 structured in a variety of manners, such as object-oriented programming languages (e.g., Objective-C, Java, or C++) or procedural programming languages (e.g., C or assembly language). In a specific example, the third-party application 1240 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1240 can invoke the API calls 1250 provided by the operating system 1212 to facilitate functionality described herein.

Examples of the systems and methods described herein address technical limitations of computerized provider-search systems by implementing a patient provider matching system 130 that programmatically transforms an initial query received from a client device 102, 104 into a constrained, machine-readable representation of user intent and a reduced set of candidate providers suitable for efficient ranking. The query subsystem 302 can generate and cause presentation, via the UI subsystem 308, of a set of supplemental questions selected based on an analysis of the initial query. In some examples, this generation and presentation can be based on ambiguity detected in the machine-readable representation of the query. Responses to the supplemental questions are converted into structured features stored in a tangible and non-transitory computer readable memory (e.g., memory 1306). These responses can be used by the ranking subsystem 304 to reduce the search space of candidate providers retrieved from the database 110. The responses also can be used to generate a ranked list using the predictive model 406 operating on defined patient information 402 and provider information 404.

The patient provider matching system 130 improves operation of computerized search and ranking by reducing repeated retrieval operations and reducing the size of candidate provider sets subjected to computationally expensive scoring and re-ranking at the ranking subsystem 304. For example, by generating and presenting supplemental questions via the UI subsystem 308 that disambiguate the query prior to ranking, the patient provider matching system 130 decreases repeated query submissions over the network 106 and reduces server-side computations that would otherwise be performed across a larger number of providers stored in the provider table 204. The patient provider matching system 130 can improve response latency by applying centroid-based location determination logic (e.g., as described with respect to operations 1108-1112 of the method 1100) to constrain candidate retrieval to a defined geographic region prior to model-based ranking by the predictive model 406. This can reduce the number of records loaded into the memory 1306 and evaluated during scoring.

Accordingly, the systems and methods described herein provide improvements in the functioning of the patient provider matching system 130 itself, including improved retrieval efficiency, reduced computational load, reduced network usage, and improved ranking stability for ambiguous or underspecified queries, while producing the ranked list of search results 412 for display on a graphical user interface of the client devices 102, 104.

The patient provider matching system 130 provides a technical improvement to computerized search and ranking by generating a machine-readable intent representation from an initial query and using that representation to control database retrieval and scoring operations. For example, the query subsystem 302 can parse an input query that may include free-form natural language and produces a structured query object stored in the memory 1306 accessible by a processor (e.g., as described with respect to the machine 1202 and the processors 1220). The structured query object can include, as one example, a query type classification indicating a physical health query type or a mental health query type (e.g., as described with respect to FIGS. 7-10), one or more inferred specialties, one or more inferred conditions or body parts, an ambiguity score, and one or more constraints derived from patient preferences.

The ambiguity score can be computed based on at least one of a confidence value output by a classification model stored in the models sub-database 209, a plurality of candidate specialties exceeding a threshold count, and/or a predicted overlap between specialties associated with tokens of the query. When the ambiguity score satisfies an ambiguity condition, the query subsystem 302 can select one or more supplemental questions from a question set stored in memory and causes display of the selected supplemental questions as selectable user interface elements via the UI subsystem 308. In this manner, the supplemental questions are generated and selected to reduce computational uncertainty and to reduce the size of a candidate provider set that is used by the ranking subsystem 304 for downstream ranking.

The query subsystem 302 can calculate the ambiguity score as a numerical value and compare the ambiguity score to an ambiguity threshold stored in memory 1306. When the ambiguity score exceeds the ambiguity threshold, query subsystem 302 can select one or more supplemental questions from a question set stored in memory 1306 and causes display of the selected supplemental questions as selectable user interface elements via UI subsystem 308. When the ambiguity score does not exceed the ambiguity threshold, query subsystem 302 can bypass presentation of at least a portion of the question set and triggers ranking subsystem 304 to proceed with candidate retrieval and ranking using the structured query object.

Responses to the supplemental questions received by the patient provider matching system 130 at operation 1106 of the method 1100 can be converted into structured features, including categorical features and numerical features, and stored as a feature vector in the memory. The ranking subsystem 304 uses the feature vector to drive candidate generation and ranking. For example, prior to applying the predictive model 406, the ranking subsystem 304 can execute a candidate-retrieval stage that applies one or more hard constraints represented by the feature vector (including specialty constraints, network constraints, distance constraints, and appointment modality constraints) to retrieve a reduced candidate provider set from the database 110. In some implementations, the database 110 includes an index keyed by specialty and geographic region and an index keyed by procedure codes derived from claims data in the claims table 208. This can allow for retrieval of candidate provider identifiers without scanning or examining all provider records in the provider table 204.

The ranking subsystem 304 can calculate one or more location features using centroid determination logic, for example as described in connection with centroid determination and radius-based retrieval. For example, the patient provider matching system 130 can calculate a centroid of a patient geographic area represented as a polygon or a set of coordinates and can use the centroid to retrieve providers within a radius defined in the memory. In some examples, when an initial retrieval yields fewer than a threshold number of providers, the ranking subsystem 304 can increase (e.g., lengthen) the radius in one or more increments until the threshold number is met. This can help balance computational cost and coverage. This progressive expansion can reduce unnecessary processing of distant providers when a sufficient local set exists and reduces repeated search requests by converging on a target candidate set size.

After retrieval of the candidate provider(s), the ranking subsystem 304 applies the predictive model 406 to compute, for each of these candidate providers, the selection probability 408. The candidate retrieval and/or filtering can be completed before executing the predictive model 406. In some examples, the predictive model 406 operates on a defined set of patient information 402 and provider information 404, including at least one feature derived from claims and utilization data 606 in the claims table 208 and at least one feature derived from the patient reviews 604 in the review table 206 processed by the NLP model 306. The post processing logic 410 can then be applied to the output selection probability 408 to apply the system preference criteria 414 as deterministic constraints and/or re-ranking adjustments to generate the ranked list of search results 412. By applying candidate reduction prior to model evaluation and by using structured features and indexed retrieval, the patient provider matching system 130 can reduce processor and memory usage relative to approaches that evaluate larger provider sets using repeated user-driven filtering.

In example examples, the NLP model 306 produces review highlights (e.g., the verified patient reviews 814) by executing the entities and aspects extraction module 506 and the aspect-based sentiment analysis module 508 to generate provider-level aggregates. The provider-level aggregates can be computed offline and stored as a compact representation in the database 110, such as in a provider-level data structure keyed by provider identifier. At query time, the ranking subsystem 304 can access the stored provider-level aggregates rather than reprocessing raw review text from the review table 206. This can improve latency and reduce compute load for ranking and rendering the provider profiles 802, 804, 1004 via the UI subsystem 308.

Accordingly, the patient provider matching system 130 is necessarily rooted in computer technology and improves computerized provider-search operations by transforming natural language queries into structured features, reducing candidate set size using indexed retrieval and ambiguity-driven supplemental question selection, and reducing repeated searches and compute-intensive operations during ranking and display at the client devices 102, 104.

The operations described herein can be performed by one or more processors executing stored instructions (e.g., the instructions 1310) to control database retrieval from the database 110, feature construction by the query subsystem 302, model execution by the ranking subsystem 304 using models stored in the models sub-database 209, and user interface rendering by the UI subsystem 308. The system architecture improves operation of the patient provider matching system 130 by reducing the volume of records that must be evaluated during ranking, reducing repeated query submissions over the network 106, reducing runtime natural language processing by using provider-level aggregates generated by the NLP model 306, and reducing end-to-end latency for generating and displaying ranked list of the search results 412 on the client devices 102, 104.

### Machine Architecture

FIG. 13 is a diagrammatic representation of the machine within which instructions 1310 (e.g., software, a program, an application, an applet, an app, or other executable code) for causing the machine to perform any one or more of the methodologies discussed herein may be executed. For example, the instructions 1310 may cause the machine to execute any one or more of the methods described herein. The instructions 1310 transform the general, non-programmed machine into a particular machine programmed to carry out the described and illustrated functions in the manner described. The machine may operate as a standalone device or may be coupled (e.g., networked) to other machines. In a networked deployment, the machine may operate in the capacity of a server machine or a client machine in a server-client network environment, or as a peer machine in a peer-to-peer (or distributed) network environment. The machine may comprise, but not be limited to, a processor dedicated to executing the instructions 1310, sequentially or otherwise, that specify actions to be taken by the machine. Further, while only a single machine is illustrated, the term “machine” shall also be taken to include a collection of machines that individually or jointly execute the instructions 1310 to perform any one or more of the methodologies discussed herein. The machine, for example, may comprise the member-related client device 102, member-related client device 104, or any one of a number of server devices in a patient provider matching system 130. In some examples, the machine may also comprise both client and server systems, with certain operations of a particular method or algorithm being performed on the server-side and with certain operations of the particular method or algorithm being performed on the client-side.

The machine may include processors 1304, memory 1306, and input/output I/O components 638, which may be configured to communicate with each other via a bus 1340. In an example, the processors 1304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, one or more processors that execute the instructions 1310. The term “processor” is intended to include multi-core processors that may comprise two or more independent processors (sometimes referred to as “cores”) that may execute instructions contemporaneously. Although FIG. 13 shows multiple processors 1304, the machine may include a single processor with a single core, a single processor with multiple cores (e.g., a multi-core processor), multiple processors with a single core, multiple processors with multiples cores, or any combination thereof.

The memory 1306 includes a main memory 1314, a static memory 1316 and a storage unit 1318 both accessible to the processors 1304 via the bus 1340. The main memory 1314, a static memory 1316 and storage unit 1318 both store the instructions 1310 embodying any one or more of the methodologies or functions described herein. The instructions 1310 may also reside, completely or partially, within the main memory 1314, within the static memory 1316, within machine-readable medium 1320 within the storage unit 1318, within at least one of the processors 1304 (e.g., within the processor's cache memory), or any suitable combination thereof, during execution thereof by the machine.

The I/O components 1302 may include a wide variety of components to receive input, provide output, produce output, transmit information, exchange information, capture measurements, and so on. The specific I/O components 1302 that are included in a particular machine will depend on the type of machine. For example, portable machines such as mobile phones may include a touch input device or other such input mechanisms, while a headless server machine will likely not include such a touch input device. It will be appreciated that the I/O components 1302 may include many other components that are not shown in FIG. 13. In various examples, the I/O components 1302 may include user output components 1326 and user input components 1328. The user output components 1326 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1328 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1302 may include biometric components 1330, motion components 1332, environmental components 1334, or position components 1336, among a wide array of other components. For example, the biometric components 1330 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1332 include acceleration sensor components (e.g., accelerometer), gravitation sensor components, rotation sensor components (e.g., gyroscope).

The environmental components 1334 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

The position components 1336 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1302 further include communication components 1338 operable to couple the machine to a network 1322 or devices 1324 via respective coupling or connections. For example, the communication components 1338 may include a network interface component or another suitable device to interface with the network 1322. In further examples, the communication components 1338 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1324 may be another machine or any of a wide variety of peripheral devices (e.g., a peripheral device coupled via a USB).

Moreover, the communication components 1338 may detect identifiers or include components operable to detect identifiers. For example, the communication components 1338 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1338, such as location via Internet Protocol (IP) geolocation, location via Wi-Fi® signal triangulation, location via detecting an NFC beacon signal that may indicate a particular location, and so forth.

The various memories (e.g., main memory 1314, static memory 1316, and memory of the processors 1304) and storage unit 1318 may store one or more sets of instructions and data structures (e.g., software) embodying or used by any one or more of the methodologies or functions described herein. These instructions (e.g., the instructions 1310), when executed by processors 1304, cause various operations to implement the disclosed examples.

The instructions 1310 may be transmitted or received over the network 1322, using a transmission medium, via a network interface device (e.g., a network interface component included in the communication components 1338) and using any one of several well-known transfer protocols (e.g., hypertext transfer protocol (HTTP)). Similarly, the instructions 1310 may be transmitted or received using a transmission medium via a coupling (e.g., a peer-to-peer coupling) to the devices 1324.

FIG. 14 is a functional block diagram of an example neural network 1402 that can be used for the inference engine or other functions (e.g., engines) as described herein to produce a predictive model. The predictive model can identify a list of medical providers to recommend for a particular patient. A predictive model can also identify supplemental questions to provide for a particular patient in order to determine which medical providers to recommend for the patient. A predictive model can also be used to identify a probability that a patient will select a particular medical provider.

In an example, the neural network 1402 can be a LSTM neural network. In an example, the neural network 1402 can be a recurrent neural network (RNN). The example neural network 1402 may be used to implement the machine learning as described herein, and various implementations may use other types of machine learning networks. The neural network 1402 includes an input layer 1404, a hidden layer 1408, and an output layer 1412. The input layer 1404 includes inputs 1404a, 1404b . . . 1404n. The hidden layer 1408 includes neurons 1408a, 1408b . . . 1408n. The output layer 1412 includes outputs 1412a, 1412b . . . 1412n.

Each neuron of the hidden layer 1408 receives an input from the input layer 1404 and outputs a value to the corresponding output in the output layer 1412. For example, the neuron 1408a receives an input from the input 1404a and outputs a value to the output 1412a. Each neuron, other than the neuron 1408a, also receives an output of a previous neuron as an input. For example, the neuron 1408b receives inputs from the input 1404b and the output 1412a. In this way the output of each neuron is fed forward to the next neuron in the hidden layer 1408. The last output 1412n in the output layer 1412 outputs a probability associated with the inputs 1404a-1404n. Although the input layer 1404, the hidden layer 1408, and the output layer 1412 are depicted as each including three elements, each layer may contain any number of elements. Neurons can include one or more adjustable parameters, weights, rules, criteria, or the like.

In various implementations, each layer of the neural network 1402 must include the same number of elements as each of the other layers of the neural network 1402. For example, training patient information data features may be processed to create the inputs 1404a-1404n. The neural network 1402 may implement a model to produce a list of medical providers, a set of supplemental questions and/or a probability that a patient will select a given medical provider. More specifically, the inputs 1404a-1404n can include patient information data features (binary, vectors, factors or the like) stored in the storage device 110. The patient information data features can specify at least one of or combination of a reason for an upcoming visit, past medical professional recommendations, past treatment recommendations, electronic health record, past claims information for the patient, patient health information, patient demographic information, prior bloodwork results, prior results of non-bloodwork tests, medical history, medical provider notes in the electronic health record, intake forms completed by the patient, patient in-network insurance coverage, patient out-of-network insurance coverage, patient location, and/or one or more treatment preferences. The patient information data can be accessed from the member table 202.

The patient information data features can be provided to neurons 1408a-1408n for analysis and connections between the known facts. The neurons 1408a-1408n, upon finding connections, provides the potential connections as outputs to the output layer 1412, which determines a list of medical providers, a set of supplemental questions and/or a probability that a patient will select a given medical provider.

The neural network 1402 can perform any of the above calculations. The output of the neural network 1402 can be used to trigger service of care type selection to recommend to a patient in a graphical user interface. For example, the notification can be provided to a pharmacy benefits manager, health plan manager, pharmacy, physician, caregiver, and/or a patient.

In some embodiments, a convolutional neural network may be implemented. Similar to neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 1404a is connected to each of neurons 1408a, 1408b . . . 1408n.

The neural network 1420 can operate on the patient data and/or the provider data to generate predictive models of possible providers that meet a patient's query, according to the methods and systems described herein. In an example, the predictive model, can also be used to provide select supplemental question of the set of supplemental questions. The selected questions can be transmitted for display as selectable user interface elements on a graphical user interface of the client device. The neural network 1420 can also generate a predictive model to determine a probability that the patient user will select a provider associated with the search result based on a set of patient data associated with the patient user and a set of provider data associated with the provider. The predictive model can produce a ranked search result based on the determined probability and a set of system preference criteria (which can be selected as predictive by the neural network.

The models can also identify the specialty of a provider by applying the model to the health records of patients who have seen that doctor or to billing codes as submitted by the provider to predict the actual medical work performed by the health provider. The identified specialty can then be weighted more heavily in the ranked output of provider lists to a potential patient.

The present application refers to U.S. patent application Ser. No. 17/533,993, filed 23 Nov. 2021, titled PATIENT PROVIDER MATCHING SYSTEM, which is incorporated by reference herein. If the disclosure of U.S. patent application Ser. No. 17/533,993 conflicts with the present application, the present application controls.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

What is claimed is:

1. A computer-implemented method comprising:
receiving, at a patient-provider matching system, a query from a patient user on a client device;
generating, based on an analysis of the query, a set of supplemental questions;
causing presentation of the supplemental questions on a graphical user interface of the client device;
receiving responses to the supplemental questions;
identifying, prior to model-based ranking, a reduced set of candidate providers constrained by the responses and by a location determined for the client device; and
generating, using a predictive model operating on patient data and provider data, a ranked list of the candidate providers based at least in part on selection probabilities and on system preference criteria, and causing display of the ranked list on the client device.

2. The method of claim 1, wherein generating the set of supplemental questions is responsive to ambiguity detected in a machine-readable representation of the query.

3. The method of claim 1, further comprising:
converting the responses into structured features stored in a memory accessible to the patient-provider matching system.

4. The method of claim 3, further comprising:
retrieving the reduced set of candidate providers by applying the structured features as hard constraints to a database index keyed by specialty and geographic region.

5. The method of claim 1, wherein determining the location includes computing a centroid of a geographic area associated with the patient user.

6. The method of claim 5, further comprising:
progressively increasing a retrieval radius around the centroid until a threshold number of candidate providers is identified.

7. The method of claim 1, further comprising:
using claims data to identify neighboring regions within a distance of the location; and
retrieving candidate providers from the neighboring regions when a local candidate count is below a threshold.

8. The method of claim 1, wherein generating the ranked list further uses provider review highlights produced by a natural language processing model that extracts aspects and sentiments from verified patient reviews.

9. The method of claim 8, wherein provider-level aggregates of the review highlights are precomputed and stored for retrieval at query time.

10. The method of claim 1, wherein the predictive model comprises a logistic regression model.

11. The method of claim 1, wherein causing display of the ranked list includes causing display of a map visualization indicating locations of the candidate providers.

12. A patient-provider matching system comprising:
one or more processors; and
a memory storing instructions that, when executed by the one or more processors, cause the system to perform operations comprising:
receiving a query from a patient user on a client device;
generating, based on an analysis of the query, a set of supplemental questions;
presenting the supplemental questions on a graphical user interface;
receiving responses to the supplemental questions;
identifying, prior to model-based ranking, a reduced set of candidate providers constrained by the responses and by a location associated with the client device;
generating, using a predictive model operating on patient data and provider data, a ranked list of the candidate providers based at least in part on selection probabilities and on system preference criteria; and
causing presentation of the ranked list on the client device.

13. The system of claim 12, wherein the instructions are further executable to:
compute an ambiguity score for the query; and
select the supplemental questions when the ambiguity score satisfies a condition.

14. The system of claim 12, wherein when a provider has multiple practice locations, the instructions are further executable to:
retain only a location closest to the location that is determined for inclusion in the ranked list.

15. A computer-generated provider recommendation presentation for responding to a patient query, comprising:
receiving a patient query;
generating a candidate set of provider entries for the patient query;
reducing the candidate set by applying constraints derived from responses to system-generated disambiguation prompts, the prompts being selected in response to ambiguity detected in a machine-readable representation of the query;
applying a device-associated location constraint defined with respect to a centroid of a patient-associated area to further reduce the candidate set;
ranking the provider entries to obtain a ranked set ordered according to selection-likelihood values computed from patient features and provider features and adjusted by system criteria; and
encoding the presentation for rendering on a client device.

16. The presentation of claim 15, wherein selecting the system-generated disambiguation prompts includes:
computing an ambiguity score for the machine-readable representation of the query; and
selecting one or more prompts when the ambiguity score exceeds a predetermined threshold.

17. The presentation of claim 15, wherein applying the device-associated location constraint includes computing a centroid as a geometric centroid of a polygon representing the patient-associated area.

18. The presentation of claim 17, wherein applying the device-associated location constraint includes progressively increasing a retrieval radius around the centroid until at least a threshold number of provider entries remains in the candidate set.

19. The presentation of claim 15, wherein the selection-likelihood values are output by a logistic regression model trained on the patient features and the provider features.

20. The presentation of claim 15, wherein the provider features include provider review highlights generated by a natural language processing model that extracts one or more aspects and corresponding sentiments from verified patient reviews.
